(19) United States
(12) Patent Application Publication
(10) Pub. No.: US 2023/0054377 A1
(43) Pub. Date: Feb. 23, 2023

(54) REMOTE COMMUNICATION SUPPORT SYSTEM CAPABLE OF SUPPRESSING UNNECESSARY LEAKAGE OF INFORMATION

(71) Applicant: KYOCERA Document Solutions Inc., Osaka (JP)

(72) Inventor: Ryo Shiomi, Osaka (JP)

(21) Appl. No.: 17/820,797

(22) Filed: Aug. 18, 2022

(30) Foreign Application Priority Data
Aug. 23, 2021 (JP) 2021-135553

(51) Int. Cl. G06V 10/22; H04N 7/15

(52) U.S. Cl. CPC G06V 10/225; H04N 7/152

(57) ABSTRACT

A remote communication support system includes a transmission device and a receiving device. The receiving device is connected to the transmission device via a network. The transmission device includes an imaging portion, a control portion, and a communication portion. The imaging portion images an image. The control portion processes the image imaged by the imaging portion in accordance with a rule corresponding to a mask-release level for a communication counterparty. The communication portion transmits the image processed by the control portion to the receiving device of the communication counterparty.

### INCORPORATION BY REFERENCE

This application is based upon and claims the benefit of priority from the corresponding Japanese Patent Application No. 2021-135553 filed on Aug. 23, 2021, the entire contents of which are incorporated herein by reference.

### BACKGROUND OF THE INVENTION

### Field of the Invention

The present disclosure relates to a remote communication support system.

An image processing apparatus intended for supporting smooth remote communication has been known which generates a natural composite image by adaptively correcting a foreground showing an image of a user and a background to be composited to the foreground based on the image quality difference between them.

### SUMMARY OF THE INVENTION

A remote communication support system according to the present disclosure includes a transmission device and a receiving device. The receiving device is connected to the transmission device via a network. The transmission device includes an imaging portion, a control portion, and a communication portion. The imaging portion images an image. The control portion processes the image imaged by the imaging portion in accordance with a rule corresponding to a mask-release level for a communication counterparty. The communication portion transmits the image processed by the control portion to the receiving device of the communication counterparty.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing an example of a configuration of a remote communication support system according to an embodiment.

FIG. 2 is a block diagram showing an example of a circuit configuration of a transmission device.

FIG. 3 is a flow chart of an example of an operation of a control portion.

### DETAILED DESCRIPTION OF THE PREFERRED EMBODIMENTS

An embodiment of the present disclosure will be described with reference to the attached drawings. Note that identical or equivalent portions in the drawings are provided with the same reference numerals and symbols and will not be repeatedly described.

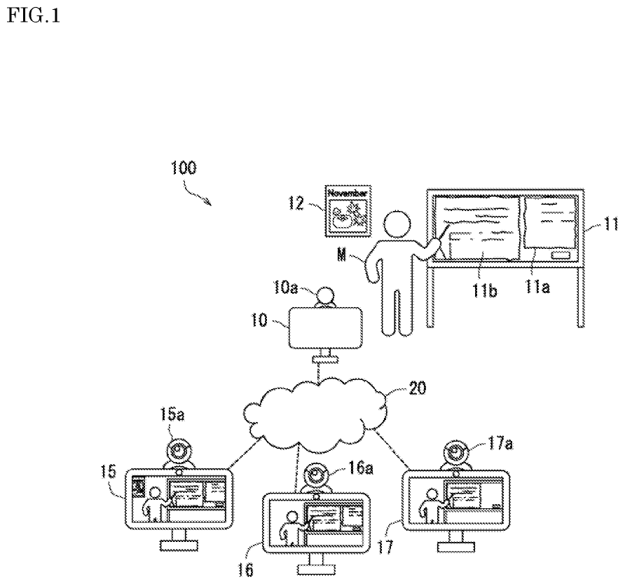

To begin with, a remote communication support system 100 according to an embodiment will be described with reference to FIG. 1. FIG. 1 is a block diagram showing an example of a configuration of the remote communication support system 100.

With reference to FIG. 1, the remote communication support system 100 is a system which supports a remote conference attended by four members. The following description will be given presupposing that one of the four members is a sender and the other three are receivers (the first through the third communication counterparties). The remote communication support system 100 includes a transmission device 10; a first receiving device 15; a second receiving device 16; and a third receiving device 17. The transmission device 10 and the first through the third receiving devices 15-17 are communicably connected via a network 20.

The transmission device 10 includes an imaging portion 10a including a speaker and a microphone. The sender stands in front of the imaging portion 10a and explains the discussion items orally while writing the main points for the conference on a whiteboard 11. A camera image with voice taken by the imaging portion 10a includes an image of the whiteboard 11, an image of a person M standing next to the whiteboard 11, and an image of a calendar 12 hung on the wall behind the whiteboard 11. The person M is the sender. A recording surface of the whiteboard 11 includes a first region 11a framed with green lines and a second region 11b framed with blue lines.

Meanwhile, an image processing apparatus intended for supporting smooth remote communication has been known which generates a natural composite image by adaptively correcting a foreground showing an image of a user and a background to be composited to the foreground based on the image quality difference between them.

However, in the conventional image processing apparatus mentioned above, unnecessary leakage of information may occur because it is not capable of changing the correction of the image in accordance with the communication counterparty.

On the contrary, the remote communication support system 100 according to an embodiment of the present disclosure is capable of suppressing unnecessary leakage of information as will be described below.

A camera image imaged by the imaging portion 10a is processed in accordance with the rule corresponding to the mask-release level for the communication counterparty. The processing by the imaging portion 10a includes masking an object by techniques such as blurring, mosaicing, and composition so that the object cannot be perceived. The transmission device 10 transmits camera images processed in different manners for different communication counterparties respectively to the first through the third receiving devices 15-17.

The first receiving device 15 includes a monitor which includes an imaging portion 15a including a speaker and a microphone. The image displayed on a monitor of the first receiving device 15 is viewed by the first communication counterparty. The monitor of the first receiving device 15 displays the camera image imaged by the imaging portion 10a as-is.

The second receiving device 16 includes an imaging portion 16a including a speaker and a microphone. The image displayed on a monitor of the second receiving device 16 is viewed by the second communication counterparty. The monitor of the second receiving device 16 displays a camera image including a masked image of the calendar 12.

The third receiving device 17 includes a monitor including an imaging portion 17a including a speaker and a microphone. The image displayed on a monitor of the third receiving device 17 is viewed by the third communication counterparty. A monitor of the third receiving device 17 displays a camera image including masked images of the calendar 12 and the first region 11a on the recording surface of the whiteboard 11.

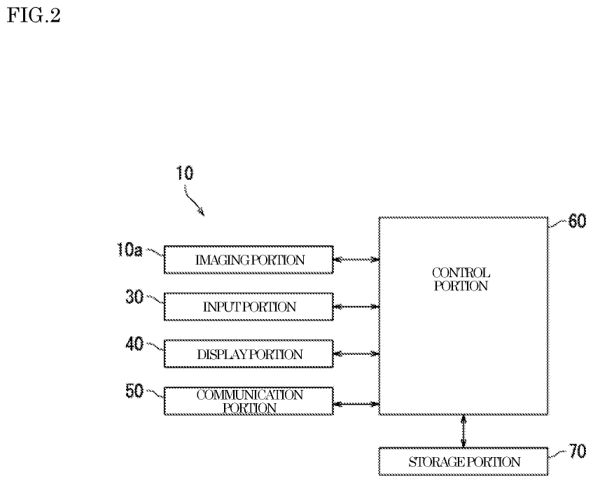

Next, a circuit configuration of the transmission device 10 will be described with reference to FIG. 1 and FIG. 2. FIG. 2 is a block diagram showing an example of the circuit configuration of the transmission device 10.

With reference to FIG. 2, the transmission device 10 including the imaging portion 10a also includes an input portion 30; a display portion 40; a communication portion 50; a control portion 60; and a storage portion 70.

The input portion 30 receives an operation input. The input portion 30 includes, for example, a keyboard and a mouse.

The display portion 40 displays a camera image imaged by the imaging portion 10a as-is. The display portion 40 includes, for example, a liquid crystal display.

The communication portion 50 performs a communication via the network 20. The network 20 includes the Internet, for example.

The storage portion 70 includes a storage device and stores data and computer programs. The storage portion 70 includes a main storage device such as a semiconductor memory and an auxiliary storage device such as a hard disk drive (HDD).

The control portion 60 includes a processor such as a central processing unit (CPU) and executes the computer programs stored on the storage portion 70 to control the components of the transmission device 10.

In particular, the control portion 60 processes the camera image imaged by the imaging portion 10a in accordance with the rule corresponding to the mask-release level for the communication counterparty. Examples of the rule to be applied include the following rules, the first through the third rules.

First rule: For a communication counterparty for whom the mask-release level “3” has been designated, the control portion 60 applies no display mask to any region on the recording surface of the whiteboard 11. In addition, the control portion 60 applies no display mask to any region included in the background located outside the recording surface of the whiteboard 11.

Second rule: For a communication counterparty for whom the mask-release level “2” has been designated, the control portion 60 applies no display mask to any region on the recording surface of the whiteboard 11. Provided, however, that if any distinctive region (e.g., a portion showing the image of the calendar 12) has been detected in the background located outside the recording surface of the whiteboard 11, the control portion 60 applies a display mask to the detected region.

Third rule: For a communication counterparty for whom the mask-release level “1” has been designated, the control portion 60 applies a display mask to a region framed with lines (e.g., the first region 11a) of a specific color (e.g., green) included in the recording surface of the whiteboard 11. In addition, the control portion 60 applies a display mask to a distinctive region (e.g., a portion showing the image of the calendar 12) in the background located outside the recording surface of the whiteboard 11.

The control portion 60 detects display mask region candidates that are candidates for regions to be masked with a display mask, from the camera image imaged by the imaging portion 10a and determines a processing object from among the display mask region candidates in accordance with the rules described above. For example, the control portion 60 detects, as a display mask region candidate, the first region 11a framed with the green lines on the recording surface of the whiteboard 11. In addition, for example, the control portion 60 detects, as a display mask region candidate, a portion showing an image of the calendar 12 included in the background located outside the recording surface of the whiteboard 11.

In the example shown in FIG. 1, the mask-release level “3” has been designated for the first communication counterparty who views the information displayed on the monitor of the first receiving device 15. For the second communication counterparty who views the information displayed on the monitor of the second receiving device 16, the mask-release level “2” has been designated. For the third communication counterparty who views the information displayed on the monitor of the third receiving device 17, the mask-release level “1” has been designated. The designations for the mask-release level for the respective communication counterparties described above are previously stored in the storage portion 70.

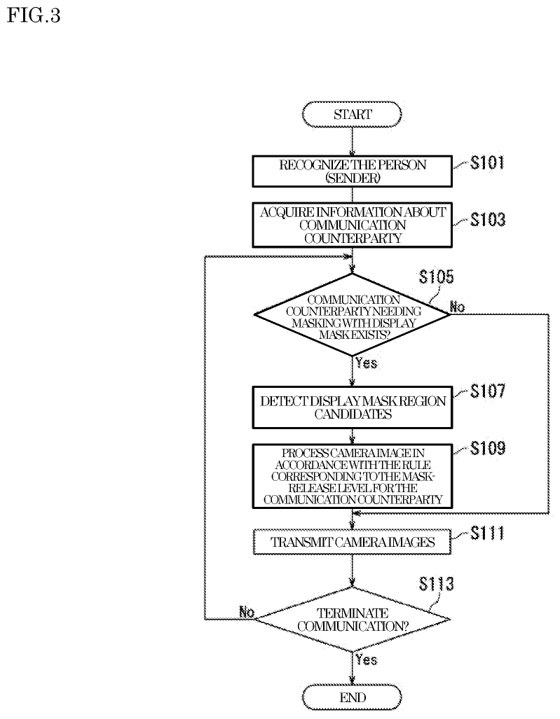

Next, an operation of the control portion 60 will be described with reference to FIG. 1 through FIG. 3. FIG. 3 is a flow chart of an example of an operation of the control portion 60.

Step S101: With reference to FIG. 3, the control portion 60 recognizes a person M from the camera image imaged by the imaging portion 10a. The person M is a sender. When the processing in steps S101 is completed, the processing by the control portion 60 advances to step S103.

Step S103: The control portion 60 acquires information about the communication counterparty. In this example, the control portion 60 confirms that the first communication counterparty, the second communication counterparty, and the third communication counterparty are currently participating in the remote conference. Further, the control portion 60 confirms that the mask-release level “3”, “2”, and “1” have been designated for the first through the third communication counterparty, respectively. When the processing in step S103 is completed, the processing by the control portion 60 advances to step S105.

Step S105: The control portion 60 determines whether any communication counterparty for whom a display mask needs to be applied exists in the first through the third communication counterparties. The communication counterparty for whom the mask-release level “2” or “1” has been designated is the communication counterparty for whom a display mask needs to be applied. When the control portion 60 determines that a communication counterparty for whom a display mask needs to be applied exists (Yes in step S105), then the processing by the control portion 60 advances to step S107. When the control portion 60 determines that no communication counterparty for whom a display mask needs to be applied exists (No in step S105), then the processing by the control portion 60 advances to step S111.

Step S107: The control portion 60 detects display mask region candidates from the camera image imaged by the imaging portion 10a. Specifically, the control portion 60 detects the first region 11a on the recording surface of the whiteboard 11 and the portion showing an image of the calendar 12 located outside the recording surface of the whiteboard 11 as the display mask region candidates. Note that the control portion 60 may also detect the portion showing the image of the person M as another display mask region candidate. When the processing in step S107 is completed, the processing by the control portion 60 advances to step S109.

Step S109: The control portion 60 processes the camera image in accordance with the rule corresponding to the mask-release level for the communication counterparty. In this example, the control portion 60 determines that no display mask region candidate is adopted for the first communication counterparty for whom the mask-release level “3” has been designated. In addition, for the second communication counterparty for whom the mask-release level “2” has been designated, the control portion 60 determines, as a processing object, only the portion showing the image of the calendar 12, from among the display mask region candidates. Moreover, for the third communication counterparty for whom the mask-release level “1” has been designated, the control portion 60 determines, as processing objects, the first region 11a on the recording surface of the whiteboard 11 and the portion showing the image of the calendar 12. When the processing in step S109 is completed, the processing by the control portion 60 advances to step S111.

Step S111: The control portion 60 controls the communication portion 50 to transmit the camera images processed in different manners for different communication counterparties to the first through the third receiving devices 15-17, respectively. When the processing in step S111 is completed, the processing by the control portion 60 advances to step S113.

Step S113: The control portion 60 determines whether the sender has instructed termination of the communication. When the control portion 60 determines that the sender has instructed termination of the communication (Yes in step S113), the processing by the control portion 60 ends. When the control portion 60 determines that the sender has given no instruction for terminating the communication (No in step S113), the processing by the control portion 60 returns to step S105.

According to the present embodiment, the remote communication support system 100 is provided which is capable of suppressing unnecessary leakage of information by implementing different displays of information appropriate for different communication counterparties on the first through the third receiving devices 15-17.

An embodiment of the present disclosure has been described with reference to the drawings. However, the present disclosure is not limited to the above-described embodiment and can also be implemented by various modifications within the scope not departing from the gist of the present disclosure. In addition, the present disclosure can also be implemented by various other modifications formed by an appropriate combination of multiple components disclosed in the above-described embodiment. For example, some of the components may be omitted from the components described in the embodiment. The drawings schematically show the primary components for easier understanding, and in some embodiments of the present disclosure, the number of each component shown in the drawing and other factors may be different from an actual implementation of the present disclosure for the sake of easiness in the production of the drawings. Moreover, the respective components described in the above embodiment are mere examples, and the present disclosure is not particularly limited to them and can also be implemented by various modifications and alterations within the scope not substantially departing from the effects of the present disclosure.

For example, in the above-described embodiment, the mask-release level “3” is designated for the first communication counterparty, the mask-release level “2” is designated for the second communication counterparty, and the mask-release level “1” is designated for the third communication counterparty. However, the present disclosure is not limited to this configuration. In another embodiment, the control portion 60 may prompt group registration of members participating in a remote conference and designate a mask-release level for each group, for example. In this configuration, a member may belong to a plurality of groups. In yet another embodiment, in a remote conference that is similar to a previous remote conference, for a member participated in the previous remote conference, the control portion 60 may designate the same mask-release level as in the previous remote conference.

In addition, in the above-described embodiment, the control portion 60 detects the first region 11a framed with the green lines on the recording surface of the whiteboard 11 as a display mask region candidate. However, the present disclosure is not limited to the configuration. For example, the control portion 60 may detect the second region 11b framed with blue lines on the recording surface of the whiteboard 11 as a display mask region candidate. Conversely, the control portion 60 may detect, as a candidate for a region not to be masked with a display mask, a region framed with lines of a specific color on the recording surface of the whiteboard 11. In addition, the sender may draw specific marks on four corners of a region that is not to be masked with a display mask, on the recording surface of the whiteboard 11, and the control portion 60 may detect the rectangular region defined by the specific marks as a candidate for a region not to be masked with a display mask. In another embodiment, the sender may affix a sticker on which a two-dimensional barcode including information about the expiration date on the whiteboard 11 and the control portion 60 may decode the image of the two-dimensional barcode included in the camera image imaged by the imaging portion 10a and use the decoded information. In yet another embodiment, even if the control portion 60 has determined that the portion showing the image of the person M is not to be masked with a display mask, the control portion 60 may lower the resolution of the portion showing the image of the person M to a level that can prevent leakage of iris information. In another embodiment, the control portion 60 may recognize the shape of the recording surface of the whiteboard 11 and virtually set a marker showing a display mask region candidate on the recording surface. In yet another embodiment, the control portion 60 may store data including the content previously described on the recording surface of the whiteboard 11 and detect the display mask region candidates with reference to the content of the previous description.

The present disclosure is advantageous in the field of remote communication support system.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A remote communication support system comprising:
a transmission device; and
a receiving device connected to the transmission device via a network, wherein
the transmission device includes:
an imaging portion which images an image;
a control portion which processes the image imaged by the imaging portion in accordance with a rule corresponding to a mask-release level for a communication counterparty; and
a communication portion which transmits the image processed by the control portion to the receiving device of the communication counterparty.

2. The remote communication support system according to claim 1, wherein the control portion detects display mask region candidates that are candidates for regions to be masked with a display mask, from the image imaged by the imaging portion and determines a processing object from among the display mask region candidates in accordance with the rule.

3. The remote communication support system according to claim 2, wherein the control portion detects, as a display mask region candidate, a region framed with lines of a specific color on a recording surface of a whiteboard.

4. The remote communication support system according to claim 2, wherein the control portion detects, as a display mask region candidate, a region included in a background located outside the recording surface of the whiteboard.
